(19) United States
(12) Patent Application Publication
(10) Pub. No.: US 2022/0258200 A1
(43) Pub. Date: Aug. 18, 2022

(54) REFILLABLE MASTIC CARTRIDGE, DISPENSER, FILLING STATION AND SYSTEM COMPRISING A MASTIC CARTRIDGE, A DISPENSER AND A FILLING STATION, AS WELL AS CARTRIDGE AND CONNECTOR FOR A CARTRIDGE

(71) Applicant: Sulzer Mixpac AG, Haag (CH)

(72) Inventor: Marco FREI, Ruthi (CH)

(21) Appl. No.: 17/630,390

(22) PCT Filed: Jul. 1, 2020
(86) PCT No.: PCT/EP2020/068440

§ 371 Date: Jan. 26, 2022

(30) Foreign Application Priority Data
Jul. 29, 2019 (EP) 19188750.4

(51) Int. Cl. B05C 17/005; B65D 83/00; B65B 29/10

(52) U.S. Cl. CPC B05C 17/00553; B65B 29/10; B65D 83/0055

(57) ABSTRACT

A refillable mastic cartridge for a mastic medium to be dispensed includes a rigid head part having a dispensing outlet, and a mastic cartridge chamber configured to store a component of the mastic medium to be dispensed from the mastic cartridge via the dispensing outlet.

### CROSS-REFERENCE TO RELATED APPLICATIONS

This application is a U.S. National Stage application of International Application No. PCT/EP2020/068440, filed Jul. 1, 2020, which claims priority to European Patent Application No. 19188750.4, filed Jul. 29, 2019, the contents of which are hereby incorporated herein by reference.

### BACKGROUND

### Field of the Invention

The present disclosure relates to a refillable mastic cartridge for a mastic medium to be dispensed. The disclosure further relates to a dispenser for dispensing a medium from the mastic cartridge, a filling station configured to fill a mastic cartridge and a system comprising a mastic cartridge, a dispenser and a filling station. The present disclosure further relates to a cartridge and a connector, wherein the connector is sealingly insertable into and removable from an aperture of a head part of the cartridge.

### Background Information

Mastic materials are commonly used in the industrial sector, such as for example in the construction industry or in the transportation industry. Mastic cartridges filled with components of a mastic medium are frequently used to store the mastic materials and to dispense them for the respective application as required. Examples for such a mastic medium are joint sealing compounds or adhesives common for example in the construction sector. These cartridges are usually produced from plastic and are manufactured in an injection molding process.

A distinction is made between single-component systems in which the material to be dispensed is only made of one component and two-component or multicomponent systems in which at least two different components are stored in separate chambers of the same cartridge or in separate cartridges, wherein the components are intimately mixed on dispensing by a dynamic or static mixing apparatus. Examples for this are two-component adhesives which only harden after the mixing of the two components. Two-component systems are in particular also used in the industrial sector for paints which are often used to generate functional protective layers such as for corrosion protection. Other applications are found for oil and petroleum products or for mastic asphalt concrete.

### SUMMARY

Conventional cartridges filled with a mastic medium are usually designed for one-way use. Due to its adhesive nature, the mastic medium will usually never be entirely dispensed from the cartridge and residues will be left over within the cartridge. At present it is therefore common practice to not refill mastic cartridges. This causes considerable waste.

For this reason, it is an object of the present disclosure to create a mastic cartridge for dispensing a mastic medium to reduce a required storage space for storing the mastic cartridges as well to lower a carbon footprint. It is a further object of the invention to create a dispenser for such a mastic cartridge and a filling station configured to fill such a mastic cartridge.

This object is satisfied by a refillable mastic cartridge for a mastic medium to be dispensed, the mastic cartridge comprising a rigid head part having a dispensing outlet. The mastic cartridge further comprises one or more mastic cartridge chambers for the storage of the respective component of the mastic medium to be dispensed from the mastic cartridge via the dispensing outlet. In particular, the cartridge chambers are configured to be refillable with the respective component of the mastic medium.

In other words, the mastic cartridge is designed to be re-used and/or the chamber of the mastic cartridge is designed to be refilled with the respective component of the mastic medium at least for a second time. Such a refillable mastic cartridge provides a plethora of new storage options. For example, a reduced number of cartridges will be brought to remote locations while storing most of the mastic medium components in one or more large containers or tanks. With this, a total weight and the space taken up by the rigidly formed cartridge chambers can be lowered. As a result, a storage space can be optimized to comprise as much mastic medium components as possible and/or to weigh as little as possible, which is particularly favorable in confined locations such as on construction sites, on oil platforms, on ships and/or on airplanes. When transporting a certain amount of the mastic medium components, a weight required to be transported including the weight of the cartridges is equally reduced as fewer cartridges are needed. Therefore, embodiments of the invention provide the further advantage of providing a possibility to reduce a carbon footprint for transporting mastic material and their respective cartridges.

This is particularly beneficial when using mastic materials in remote locations, such as construction sites or offshore platforms, where a particularly high number of mastic cartridges have to be stored on site using up a lot of a limited and much needed storage space. Furthermore, in the context of environmental protection, the avoidance of a one-way usage of a high number of plastic cartridges is particularly beneficial.

In this connection it should be noted that a mastic material is generally regarded as a material that either on its own or through the addition of a hardener solidifies on use of the respective material to form a bond at or between components. The cartridge chamber can be filled with a material, for example, with a material selected from the group of members consisting of topical medications, medical fluids, wound care fluids, cosmetic and/or skin care preparations, dental fluids, veterinary fluids, adhesive fluids, disinfectant fluids, protective fluids, paints and combinations of the foregoing. For example, the material comprises silicon, 2K adhesives or a mold material.

Preferably, the mastic cartridge can be refilled at least five or more times. Re-using refilled mastic cartridges several times enables production of even less waste than that would otherwise be created by disposing of the empty cartridges immediately after a first use.

Preferably, the mastic cartridge further comprises an Automatic Identification and Data Capture (AIDC) element. The AIDC element is configured to provide means or device for performing a method of automatically identifying predetermined objects such as the mastic medium component and/or collecting data about the predetermined object and/or forwarding the collected data to a computer system.

The AIDC element can be designed for example as a QR code, a bar code, a Radio Frequency Identification (RFID) and/or as a magnetic stripe. In particular, the AIDC is designed as an RFID element according to a preferred embodiment. The AIDC element provides the advantage of capturing and transmitting information relating to the mastic cartridge and/or its contents in an automatized manner. This allows for example a supervision of a plurality of mastic cartridges from a central server. For example, a respective state of a mastic cartridge can be determined centrally, without needing to manually examine a particular cartridge itself. Thus, it can be determined for a plurality of mastic cartridges in a faster and a more efficient manner which ones of the cartridges have to be refilled or which ones are to be disposed.

Preferably, the AIDC element comprises information relating to a material stored in said one or more mastic cartridge chambers. Alternatively or complementary to this, the AIDC element preferably comprises information relating to the number of times each mastic cartridge has been filled. For example, the chamber of the mastic cartridge is only allowed to be refilled for a predetermined number of times. Alternatively or complementary to this, the AIDC element preferably comprises information relating to the date of last filling of the mastic cartridge. For example, a time interval between two fillings is not allowed to exceed a predetermined amount of time.

Alternatively or complementary to this, the AIDC element preferably comprises information relating to a maximum storage life of media stored in said one or more mastic cartridge chambers. Alternatively or complementary to this, the AIDC element preferably comprises information relating to the correct installation of the mastic cartridge at one of a dispenser and a filling station. Alternatively or complementary to this, the AIDC element preferably comprises information relating to dispenser specific dispensing information correlated to a material stored in the mastic cartridge. Alternatively or complementary to this, the AIDC element preferably comprises information relating to a maximum number of filling cycles for said mastic cartridge.

Similarly, the AIDC element can comprise one or more of the listed pieces of information. The information comprised by the AIDC allows determining in a quick manner which further steps have to be taken for an optional functioning of the mastic cartridge or of an entire cartridge system comprising a plurality of mastic cartridges. Should there be an issue with a mastic cartridge which is part of a complex operation chain, the information provided by the AIDC element will allow to quickly detect which cartridge causes the issue, thus reducing a time of interruption during a workflow of the operation chain.

Preferably, the AIDC element comprises information on the dispensing behavior of the mastic cartridge. In particular, the dispensing behavior of the mastic cartridge comprises information relating to a dispensing pressure or a clamping of the film. Alternatively or complementary to this, accepted values relating to the dispensing behavior of the mastic cartridge are stored in the AIDC element. If a determination is made that the current dispensing behavior deviates from the accepted values, then a decision is taken to not permit a refilling of the mastic cartridge.

The information on the dispensing behavior allows for a close monitoring of a filling state of the mastic cartridge, in particular advantageous for a system comprising a plurality of mastic cartridges. In addition, analyzing the dispensing behavior allows discovering and tracking faulty cartridges, for example cartridges that leak uncontrollably or, one the contrary, are clogged. As a result, an unnecessary loss of mastic medium can be reduced.

In this connection it should be noted that the mastic cartridge can comprise one or more pieces of information with said pieces of information being listed above and stored on or at said AIDC element.

Preferably, the rigid head part of the mastic cartridge comprises alignment members. The alignment members are configured to ensure a correct, preferably mechanical, alignment of the rigid head part at a filling station. For example, for a two-component or a multicomponent system, it becomes important that a chamber of the cartridge is always refilled with the same mastic medium component such that no accidental mixing of different mastic medium components can occur within the same cartridge chamber.

The alignment members can then be configured to provide a distinguishing feature which allows an operator to distinguish between the two or more cartridge chambers of the mastic cartridge. The feature can be optical and/or haptic. For example, the alignment member can be designed as an indentation and/or as a groove and/or as a recess in the material of the rigid head part. In another example, the alignment member is a member protruding from the head part. The one or more alignment members can be located on the rigid head part in such a way that the rigid head part to be connected to a valve and/or a dispenser of a particular mastic medium component can be positioned in only one predetermined alignment. Advantageously, a wrong filling of a cartridge chamber of the mastic cartridge can be avoided thereby.

Preferably, the mastic cartridge further comprises one or more flexible films each forming a mastic cartridge wall. The one or more flexible films are bounding said one or more mastic cartridge chambers and extending at least partially in a longitudinal direction of the mastic cartridge. The one or more flexible films each comprise a front end that is sealingly and non-releasably connected to the rigid head part. The sealingly and non-releasably connection means that a possibility of leakage of the mastic medium within the cartridge during storage or use will be reduced. Furthermore, the sealingly and non-releasably connection ensures that the mastic cartridge will not detach from the head piece during normal storage and use conditions. Using film bag cartridges as refillable cartridges for mastic materials further reduces any waste that can be associated with the cartridges in comparison to solid cartridges.

For example, a front end of the film is connected to the inner circumferential surface of a collar of the head part that surrounds the dispensing outlet of the mastic cartridge in a radially outer region of the head part. The connection is realized by any one or a combination of any of the following processes: by injection molding, by glueing, by welding, in particular ultrasonic welding, by shrinking, by clamping or by mounting. In this connection it should also be noted that a flexible film bag is a film bag that can be folded together in the empty state, e.g. in the manner of a concertina, and that after filling and a possible dispensing of the mastic medium present therein can be unfolded and refolded without the film bag being damaged or becoming limited in its function.

Preferably, the mastic cartridge further comprises one or more rigid mastic cartridge walls each bounding the one or more mastic cartridge chambers and extending at least partially in a longitudinal direction of the mastic cartridge. Each rigid mastic cartridge wall comprises a front end that is sealingly and non-releasably connected to the rigid head part. The connection between a rigid mastic cartridge wall to the rigid head part can be realized similar to the connection between the collar and the front end of the film by any one or a combination of any of the following processes: by injection molding, by glueing, by welding, in particular ultrasonic welding, by shrinking, by clamping or by mounting.

According to a further aspect embodiments of the present invention relate to a dispenser for dispensing a medium from a mastic cartridge, the dispenser comprising a control and evaluation unit adapted to communicate with an AIDC element of the mastic cartridge. In particular, the dispenser is designed for dispensing the mastic medium from the mastic cartridge according to any one of the embodiments of the invention. By allowing the AIDC element of the mastic cartridge to communicate with the dispenser, an amount of the mastic medium to be dispensed from the dispenser can be controlled depending on the state of the cartridge provided by the AIDC element. For example, the dispenser is being controlled to reduce or limit the amount of mastic medium being dispensed when the AIDC element communicates that a fill level of the mastic medium within a chamber of the cartridge is below a critical threshold or the mastic cartridge is not installed properly on the dispenser.

The advantages associated with the cartridge likewise hold true for the corresponding features of the dispenser.

According to another aspect embodiments of the present invention relate to a filling station configured to fill a mastic cartridge, in particular a collapsible mastic cartridge. The filling station comprises a control and evaluation unit adapted to communicate with an AIDC element of the mastic cartridge. Preferably, the filling station is configured to fill a mastic cartridge according to embodiments of the invention. Communication between the AIDC element of the mastic cartridge and the filling station allows adapting the amount of mastic medium that is being filled into a chamber of the mastic cartridge according to the information provided by the AIDC element. For example, the cartridge is not being filled w % ben the filling station receives a notification from the AIDC element that the mastic cartridge is not correctly installed at the filling station.

Preferably, the filling station comprises counter alignment members that are formed complementary to alignment members present at the mastic cartridge. The counter alignment members are configured to ensure a correct mechanical alignment of a rigid head part of the cartridge at the filling station. The counter alignment member can be designed as a protruding member. The counter alignment member can also be designed as an indentation and/or as a groove and/or as a recess in the material of the filling station. When placing the mastic cartridge at the filling station, for example to refill the cartridge through the filling station, the alignment members of the head part of the cartridge can align with the counter alignment members of the filling station. In other words only one possible positioning of the head part of the cartridge can be allowed relative to the filling station. With this, a correct filling of each cartridge chamber of the cartridge can be ensured.

The advantages associated with the cartridge likewise hold true for the corresponding features of the filling station.

According to another aspect embodiments of the present invention relate to a system comprising a mastic cartridge for a medium to be dispensed, a dispenser for dispensing a medium from a mastic cartridge and a filling station for filling the mastic cartridge with the medium. The mastic cartridge comprises an Automatic Identification and Data Capture (AIDC) element that is configured to communicate with a corresponding element arranged at the dispenser and at the filling station. The system can comprise a mastic cartridge according any one of the embodiments according to the invention. In particular, the system comprises two or more mastic cartridges according any one of the embodiments according to the invention. The system can also comprise a dispenser according to embodiments of the invention. The system can also comprise a filling station according to embodiments of the invention. With the system, a communication chain can be set in place between the at least one mastic cartridge, the dispenser and the filling station, allowing to optimize a filling state of the cartridges as well as an amount of mastic medium to be filled into the chambers of the cartridge at the filling station. The system can comprise a memory that stores information relating to a predetermined maximal number of times that a specific component chamber of a mastic cartridge is allowed to be refilled. The memory can keep track of the actual number of times the specific chamber has been filled. The system can adapt a refilling strategy according to the information stored by the memory. Each cartridge can comprise its own memory and/or a central server receiving information from the AIDC elements of each cartridge can comprise a memory storing the information for each cartridge.

The advantages associated with the cartridge respectively with the dispenser and respectively with the filling station likewise hold true for the corresponding features of the system.

According to another aspect embodiments of the present invention relate to a cartridge, in particular a mastic cartridge as discussed herein. The cartridge comprises a head part, which comprises an aperture leading from an outer side of the head part to a cartridge chamber of the cartridge. The cartridge chamber can be optionally filled with a material, as for example the mastic medium. The cartridge further comprises a connector, with said connector being sealingly insertable into and removable from the aperture. The connector can optionally further comprise a film extending over a surface of the connector with said surface facing the cartridge chamber.

According to a preferred embodiment of the cartridge, the connector is a terminal connector, i.e. the terminal connector only seals off the aperture when it is inserted into the aperture.

According to a preferred embodiment of the cartridge, the aperture is separate from an outlet of the cartridge.

According to a preferred embodiment of the cartridge, the connector comprises an outlet from the cartridge, the outlet having a passage arranged therein for connecting the cartridge chamber to a further component.

According to a preferred embodiment of the cartridge, at least one of the connector and the aperture comprises a valve.

According to a preferred embodiment of the cartridge, the valve is arranged within the passage of the outlet.

According to a preferred embodiment of the cartridge, the valve is removable from the aperture.

According to a preferred embodiment of the cartridge, the connector is sealingly inserted within the cartridge head by at least one of a screwed connection, a bayonet type of connection, a plug and rotate type of connection, an adhesive bond, a thermal welding bond, an ultrasonically welded bond, a press and/or interference fit, and a snap in connection.

According to a preferred embodiment of the cartridge, the aperture of the head part comprises an inner thread and the connector comprises an outer thread mating with the inner thread of the aperture.

According to a preferred embodiment of the cartridge, a seal is arranged between the head part and the connector.

According to a preferred embodiment of the cartridge, the seal is arranged be-tween the aperture and the connector.

According to a preferred embodiment of the cartridge, the seal is arranged at the connector.

According to a preferred embodiment of the cartridge, the aperture is configured as a filling port of the cartridge.

According to a preferred embodiment of the cartridge, the connector comprises a second thread at a side of the connector disposed opposite to the outer thread.

According to a preferred embodiment of the cartridge, a diameter of the second thread differs from a diameter of the outer thread.

According to a preferred embodiment of the cartridge, the second thread is one of an inner thread and an outer thread.

According to a preferred embodiment of the cartridge, the cartridge is one of a film bag cartridge and a solid cartridge.

According to a preferred embodiment of the cartridge, the film bag cartridge is either collapsed for filling or not collapsed for filling.

According to a preferred embodiment of the cartridge, the cartridge is one of a single component cartridge and a multi-component cartridge.

According to a preferred embodiment of the cartridge, the multi-component cartridge comprises two separate outlets with each outlet being formed by a separate connector installed in a separate aperture and with the separate the outlets being combinable to form a common outlet.

According to a preferred embodiment of the cartridge, the cartridge further comprises a further aperture configured as a filling port in said cartridge chamber and the filling port being able to be closed off in a releasable and sealing manner via a/the terminal connector.

According to a preferred embodiment of the cartridge, the terminal connector comprises a film extending over a surface facing the cartridge chamber.

According to a preferred embodiment of the cartridge, on installing the two separate connectors in the two separate outlets the two connectors are axially moved in the direction of the respective outlet and/or are rotated into the position in which they form the common outlet.

According to a preferred embodiment of the cartridge, the separate connectors are connectable to one another via at least one of a snap fit, interference fit, press fit, a mixer connectable to the common outlet, a bayonet type connection, and a ring attachable to the common outlet.

According to a preferred embodiment of the cartridge, the cartridge is one of a side by side cartridge, a click together cartridge and a coaxial cartridge.

According to a preferred embodiment of the cartridge, the film extends over the complete surface facing the cartridge chamber.

According to a preferred embodiment of the cartridge, the film comprises an aperture in the region of an outlet from said cartridge chamber.

According to a preferred embodiment of the cartridge, the film is a multi-layer film.

According to a preferred embodiment of the cartridge, the film is configured to burst in the region of an outlet on applying a dispensing pressure on the cartridge.

According to another aspect the present invention relates to a connector for a cartridge, with the connector being sealingly insertable into and removable from an aperture of a head part of the cartridge. The connector further comprises a film extending over a surface of the connector with said surface facing a cartridge chamber of the cartridge when connected to the cartridge.

According to another aspect the invention relates to a connector for a cartridge, with the connector being sealingly insertable into and removable from an aperture of a head part of the cartridge. The connector further comprises a film extending over a surface of the connector with the surface facing a cartridge chamber of the cartridge when connected to the cartridge.

The advantages associated with the cartridge likewise hold true for the corresponding features of the connector.

### BRIEF DESCRIPTION OF THE FIGURES

The invention will be explained in more detail hereinafter with reference to the drawings.

FIG. 1 is a perspective view of a two-component mastic cartridge;

FIG. 2 is a frontal view of a head part of the two-component mastic cartridge according to one embodiment of the invention;

FIG. 3 is a frontal view of a head part of the two-component mastic cartridge according to another embodiment of the invention:

FIG. 4 is a frontal view of a head part of the two-component mastic cartridge according to another embodiment of the invention;

FIG. 5 is a frontal view of a head part of the two-component mastic cartridge according to another embodiment of the invention:

FIG. 6 is a frontal view of a head part of the two-component mastic cartridge according to another embodiment of the invention:

FIG. 7 is a frontal view of a head part of the two-component mastic cartridge according to another embodiment of the invention;

FIG. 8 is a schematic view of a system comprising a central unit with a memory, a filling station and a plurality of mastic cartridges;

FIG. 9 is a perspective view of a schematically shown filling station for filling a mastic cartridge:

FIG. 10 is a schematic view of a connector for a cartridge; and

FIG. 11 is a schematic view of possible positions for connection of a connector, such as the one of FIG. 10.

### DETAILED DESCRIPTION

In the following the same reference numerals will be used for parts having the same or equivalent function. Any statements made having regard to the direction of a component are made relative to the position shown in the drawing and can naturally vary in the actual position of the application.

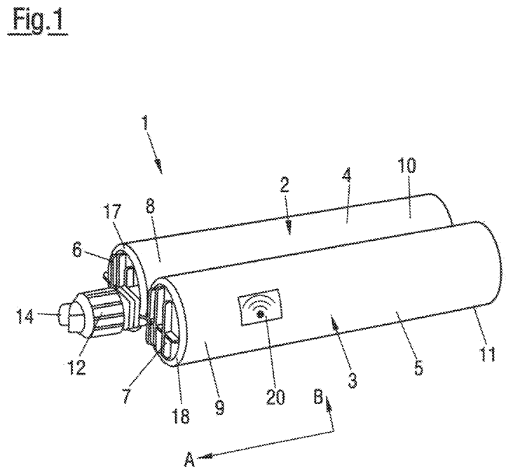

FIG. 1 shows a refillable mastic cartridge 1 configured as a two-component cartridge. The mastic cartridge 1 comprises two generally cylindrical cartridge chambers 2, 3. The cartridge chambers 2, 3 are each bound by a cartridge wall 4, 5 as well as by a head part 6, 7, with each head part 6, 7 being arranged at a respective front end 8, 9 of the cartridge wall 4, 5. Each cartridge wall 4, 5 extends in a longitudinal direction A of the mastic cartridge 1 from a respective rear end 10, 11 to the respective front end 8, 9.

Each head part 6, 7 is a stable shaped part of generally plate-like shape, which comprises a common dispensing outlet 12 via which a mastic medium (not shown) can be dispensed from the cartridge chambers 2, 3. For this, the two components of the mastic medium stored within the chambers 2, 3 mix or combine at the dispensing outlet 12 before being released outwardly as a combined mastic medium from a common outlet part 14 of the dispensing outlet 12. The dispensing outlet 12 extends from the head parts 6, 7 as an outlet passage through the common outlet part 14. A mixing tip or closure part (each not shown) can be connected to the outlet part 14.

Each head part 6, 7 has a collar 17, 18. A radial direction B is indicated relative to the arrow A used to identify the longitudinal direction A. Each collar 17, 18 has a length extending in the longitudinal direction A. The front end 8, 9 of each cartridge wall 4, 5 is sealingly and non-releasably connected to the collar 17, 18 of the head part 6, 7.

It should be noted that the cartridge 1 can also be configured as a one-component cartridge (not shown), comprising only one generally cylindrical cartridge chamber with a single head part and a film forming the cartridge wall. In the following, corresponding features of the one-component cartridge and corresponding features of the two-component cartridge 1 mutually hold true.

The cartridge chambers 2, 3 are configured to be refillable with their respective component of the mastic medium. In particular, the cartridge chambers 2, 3 can be refilled five or more times. The cartridge 1 comprises an Automatic Identification and Data Capture (AIDC) element 20, which comprises an information relating to the one or two cartridge chambers 2, 3. The cartridge 1 can also comprise two AIDC elements 20, one for each cartridge chamber 2, 3. For example, the AIDC element 20 is designed as a RFID element. The information comprised by the AIDC element 20 can comprise one or more of the following data: the type of mastic medium component stored by a particular cartridge chamber 2, 3; a number of times a cartridge chamber 2, 3 of the mastic cartridge 1 has been filled; a date of a last filling of the mastic cartridge 1 or a respective chamber 2, 3; a maximum storage life of media stored in the mastic cartridge chambers 2, 3; a maximum number of filling cycles for a mastic cartridge 1 respectively a cartridge chamber 2, 3.

Furthermore, the information comprised by the AIDC element 20 can relate to a dispensing behavior of the mastic cartridge 1. For this, a dispensing pressure at the dispensing outlet 12 can be monitored. The AIDC element 20 can also comprise an information about accepted values relating to the dispensing behavior of the mastic cartridge 1, such as accepted values for the dispensing pressure. If a determination is made that the current dispensing behavior deviates from the accepted values, then a decision is taken to not permit a refilling of the mastic cartridge 1 respectively a mastic cartridge chamber 2, 3.

The cartridge 1 is being positioned with its head parts 6, 7 at a filling station in order to refill the chambers 2, 3, for example when an information from the AIDC element 20 shows that a particular chamber 2, 3 is empty or its filling state has passed below a critical threshold. When refilling the chambers 2, 3 of the two-component mastic cartridge 1, care has to be taken in order to not accidentally refill a chamber 2, 3 with another mastic medium component than the one that has been previously been contained by the respective chamber 2, 3. As mastic medium is particularly adhesive, a chamber 2, 3 will most likely never be entirely emptied out of the mastic medium component. A mixing of different components within the chambers 2, 3 is to be avoided.

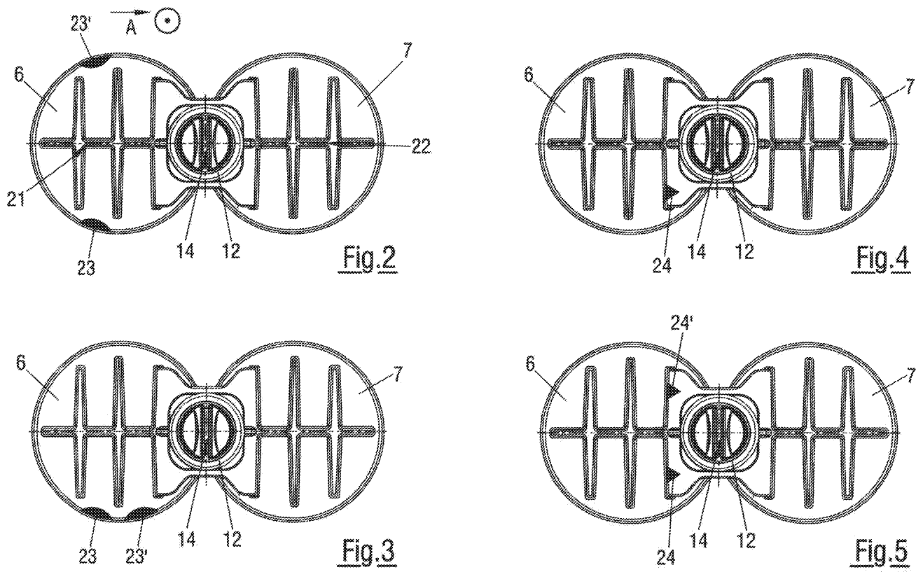

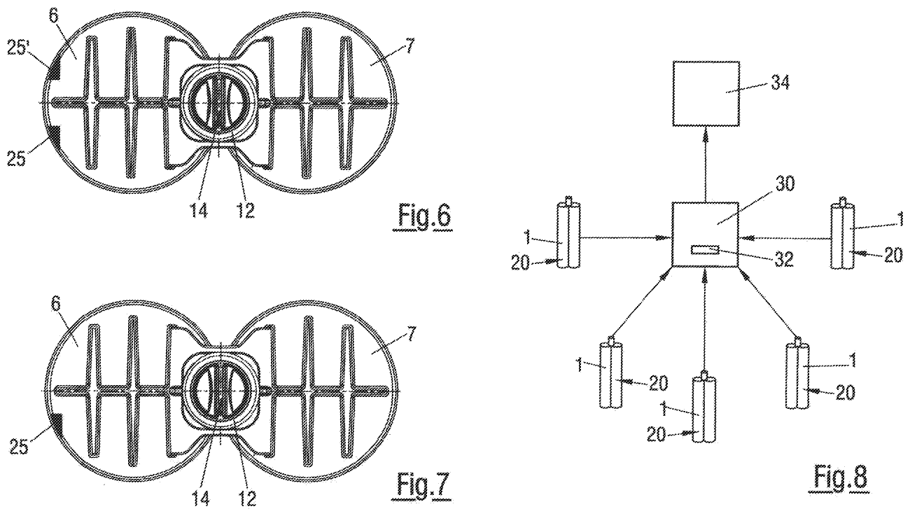

FIGS. 2-7 schematically show different embodiments of the rigid head parts 6, 7 of the cartridge 1 in a frontal view. Each of the shown head parts 6, 7 comprise a filling port 21, 22 through which the respective bounding chamber 2, 3 of the cartridge 1 can be refilled. In order to ensure the correct positioning of the cartridge 1 at the filling station, at least one of the rigid head parts 6, 7 comprises at least one alignment member 23, 23, 24, 24′, 25, 25′. The alignment members 23, 23′, 25, 25′ shown in FIGS. 2, 3, 6 and 7 are designed as indentations in the material of the respective rigid head part 6, 7. The shown indentations have a triangular or round shape, but any other shape can also be possible. The alignment members 24, 24′ shown in FIGS. 4 and 5 are designed as indentations in the material of the dispensing outlet 12. The here shown indentations 24, 24′ are equally not constrained to be of triangular shape. As shown in FIGS. 2-7, it is sufficient if only one head part 6 of the two head parts 6, 7 of the two-component cartridge 1 comprises the at least one alignment member 23, 23′, 24, 24′, 25, 25′. It is also possible for both head parts 6, 7 to comprise of an alignment member, each differently shaped and/or positioned.

The alignment members 23, 23′, 24, 24′, 25, 25′ provide a distinguishing feature between the two parts 6 and 7. With this, one can manually recognize which chamber 4, 5 of the cartridge 1 contains which mastic medium component. Furthermore, a machine can recognize the alignment members 23, 23′, 24, 24′, 25, 25′ when a positioning and refilling of the cartridge 1 at the refilled station is configured as an automatized process. For example, a member of the filling station that is to be placed on the filling ports 21 and 22 of the head parts 6, 7 of the cartridge 1 such as a valve and/or a dispenser of a particular mastic medium component comprises counter alignment members. The counter alignment members are formed complementary to alignment members 23, 23′, 24, 24′, 25, 25′ of the head parts 6, 7. For example, the counter alignment members protrude from the valve and/or the dispenser of the mastic medium component. When placing the rigid head parts 6, 7 of the cartridge 1 at the valve and/or the dispenser, the alignment members 23, 23′, 24, 24′, 25, 25′ of the head part 6 align with the counter alignment members. In this way, the filling ports 21, 22 of the two chambers 4, 5 of the cartridge 1 are correctly positioned at the filling station.

FIG. 8 shows schematically a system comprising a central processing unit 30 with a memory 32, a filling station 34 and multiple mastic cartridges 1. Each cartridge 1 comprises a AIDC element 20 which comprises information data relating to a state of the cartridge 1 as described previously. The AIDC elements 20 comprise a transmitter capable of transmitting the information to the central processing unit 30. Said central processing unit 30 is configured to store the received information from the various cartridges 1 into the memory 32. Using the information from one cartridge 1 or a combined information from multiple cartridges 1, the central processing unit 30 can determine a strategy for filling one or more cartridges 1 at the filling station 34. For example the central processing unit 30 can determine that a cartridge 1 is to be brought to the filling station 34 as soon as the transmitted AIDC element data shows that one of the chambers 4, 5 of the cartridge 1 has a filling state lower than a critical threshold filling state. As another example, the central processing unit 30 can determine that only when a certain amount of cartridge chambers 4, 5 are indicated to be empty, the corresponding cartridges 1 are to be brought to the filling station 34 and be refilled. The strategy determined by the central processing unit 30 can follow preset rules determining to create a filling process of the cartridges 1 that uses as little amount of time and/or energy as possible.

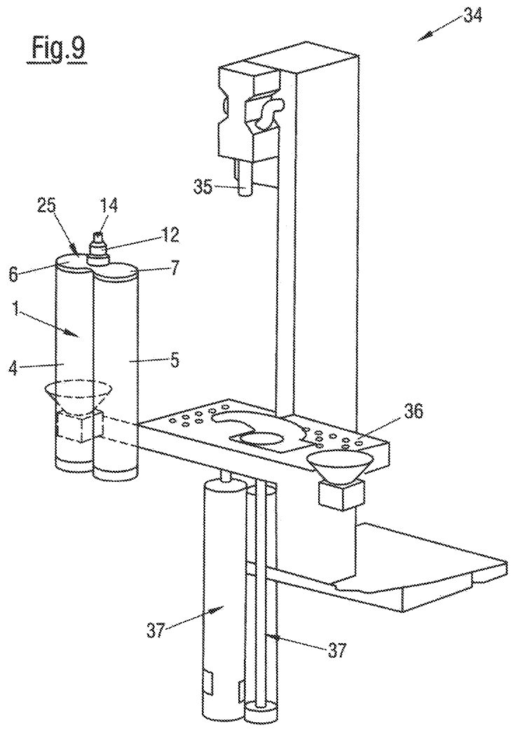

FIG. 9 shows schematically in a perspective view a filling station 34 and a cartridge 1 as shown in FIG. 1. The filling station 34 can correspond to the filling station 34 shown in FIG. 8. As shown for example by FIG. 7, the head part 6 of the cartridge 1 comprises an alignment member 25 in the shape of a triangular indentation and/or recess. The filling station 34 comprises a filling mandrel 35 which is to be positioned on the outlet part 14 of the dispensing outlet 12 of the cartridge 1. The filling mandrel 35 or a part of the filling manifold comprising the filling mandrel 35 comprises a counter alignment member which aligns with the alignment member 25 of the head part 6 when the cartridge 1 is being placed correctly on a cartridge tray 36 of the filling station 34. When it is determined that the positioning of the cartridge 1 is correct, plungers 37 of the filling station 34 can be activated in order to refill the chambers 4 and 5 of the cartridge 1. The information about a determined correct positioning of the cartridge 1 at the filling mandrel 35 can be provided via an AIDC element 20 of the cartridge 1, with said AIDC element 20 communicating with a control and evaluation unit of the filling station. The control and evaluation unit of the filling station can be located centrally on a server comprising the central processing unit 30 or can be comprised by the filling station itself.

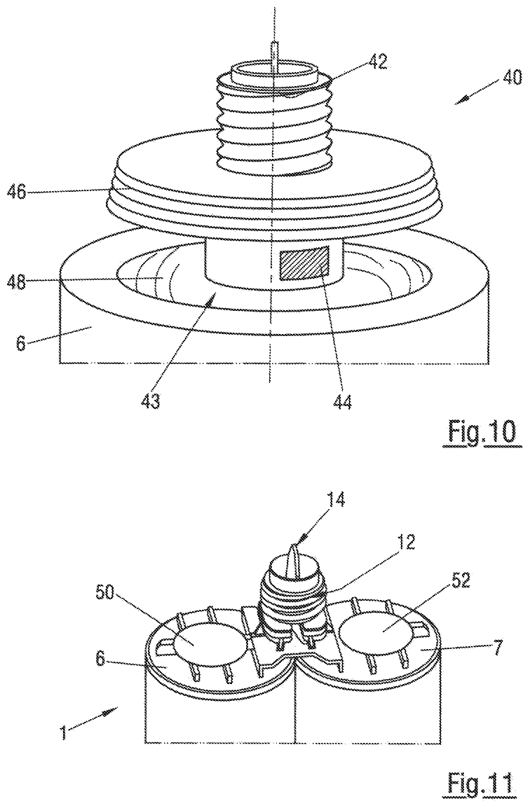

FIG. 10 shows a connector 40 for a mastic cartridge, as for example for the mastic cartridge 1. The connector 40 is designed to be connected to an aperture 43 of a head part 6 of the cartridge 1 that is for example not formed by the dispensing outlet 12 of the cartridge 1 shown by FIGS. 1-7.

The connector 40 comprises an outlet 42 having a passage arranged therein for connecting a cartridge chamber 2, 3 to a further component. When the connector 40 is connected to the cartridge head part 6, 7, the outlet 42 can correspond to an outlet of the respective cartridge chamber 2, 3 through which the mastic medium component stored within the respective cartridge chamber 2, 3 is to be dispensed. The connector further comprises at least one inlet 44 through which the mastic medium component that is to be dispensed from the cartridge chamber 2, 3 passes through.

The connector 40 further comprises an outer thread or a male thread 46 which is designed to be sealingly inserted within the aperture 43 of the cartridge 1 or one of the cartridge head parts 6, 7. The aperture 43 of the head part 6, 7 of the cartridge 1 comprises an inner thread or female thread 48 which is mating with the outer thread or male thread 46 of the connector 40. In other words, the connector 40 is designed to be screwed into the aperture 43 of the cartridge head part 6, 7 via corresponding male and female threads 46, 48. For this, an outer diameter of a cylindrically shaped male thread 46 can be chosen to correspond to an inner diameter of a cylindrically shaped aperture 43 with the female thread 48.

Alternatively to the connection formed by the male thread 46 and the female thread 48, the connector can form with the aperture 43 of the cartridge head part 6, 7 a screwed connection, a bayonet type of connection, a plug and rotate type of connection, an adhesive bond, a thermal welding bond, an ultrasonically welded bond, a press and/or interference fit, and/or a snap in connection.

The connector can be used for or alternatively be removed when refilling the respective cartridge chamber 4, 5. A filling can then occur via the outlet 42 or directly via the aperture 43. The use of such a connector 40 on filling can aid in avoiding a cross contamination between the one or more outlets from the cartridge 1 further ensuring the lifetime of the cartridge 1.

FIG. 11 schematically shows the head parts 6, 7 with the common dispensing outlet 12 of the mastic cartridge 1 as described for FIG. 1. Each head part 6, 7 comprises a filling connector port 50, 52 designed to provide a connection interface to connect the connector 40 to a respective cartridge chamber 2, 3 of the cartridge 1 via the filling connector ports 50, 52. For example, each filling connector port 50, 52 is designed as an aperture, as for example the aperture 43 shown by FIG. 10. The cartridge 1 can comprise in total two connectors 40 each allowing to dispense a respective mastic medium component stored within the chambers 2, 3 via the outlets 42 of the connectors 40. In addition or alternatively, the connectors 40 can provide a support for a filling process. For example, the outlet 42 connects to a storage container filled with the mastic medium component to be filled into the cartridge chamber 6. When it is determined that a connector 40 respectively its outlet 42 has spanned its lifetime, for example because too much residue of the mastic medium component has accumulated within a valve of the connector 40 or the outlet 42, the connector 40 can be simply replaced without having to replace the entire cartridge head part 6, 7 respectively cartridge 1.

1. A refillable mastic cartridge for a mastic medium to be dispensed, the mastic cartridge comprising:
a rigid head part having a dispensing outlet; and
mastic cartridge chamber configured to store a component of the mastic medium to be dispensed from the mastic cartridge via the dispensing outlet.

2. The mastic cartridge in accordance with claim 1, wherein the mastic cartridge is capable of being refilled 5 or more times.

3. The mastic cartridge in accordance with claim 1, further comprising an Automatic Identification and Data Capture (AIDC) element.

4. The mastic cartridge in accordance with claim 3, wherein the AIDC element is an RFID element.

5. The mastic cartridge in accordance with claim 3, wherein the AIDC element comprises information relating to a material stored in the mastic cartridge chamber; or
the AIDC element comprises information relating to a number of times the mastic cartridge has been filled; or
the AIDC element comprises information relating to a date of a last filling of the mastic cartridge; or
the AIDC element comprises information relating to a maximum storage life of media stored in the mastic cartridge chamber; or
the AIDC element comprises information relating to a correct installation of the mastic cartridge at one of a dispenser and a filling station; or
the AIDC element comprises information relating to dispenser specific dispensing information correlated to the material stored in the mastic cartridge; or
the AIDC element comprises information relating to a maximum number of filling cycles for the mastic cartridge.

6. The mastic cartridge in accordance with claim 3, wherein the AIDC element comprises information on dispensing behavior of the mastic cartridge.

7. The mastic cartridge in accordance with claim 1, wherein the rigid head part comprises alignment members configured to ensure a correct mechanical alignment of the rigid head part at a filling station.

8. The mastic cartridge in accordance with claim 1, further comprising a flexible film, the flexible film forming a mastic cartridge wall, with the flexible film bounding the mastic cartridge chamber and extending at least partially in a longitudinal direction of the mastic cartridge, the flexible film having a front end that is sealingly and non-releasably connected to the rigid head part.

9. The mastic cartridge in accordance with claim 1, further comprising a rigid mastic cartridge wall bounding the cartridge chamber and extending at least partially in a longitudinal direction of the mastic cartridge, the rigid mastic cartridge wall having a front end that is sealingly and non-releasably connected to the rigid head part.

10. A dispenser for dispensing a medium from a mastic cartridge, the dispenser comprising:
a control and evaluation unit configured to communicate with an AIDC element of the mastic cartridge.

11. A filling station configured to fill a mastic cartridge, the filling station comprising:
a control and evaluation unit configured to communicate with an AIDC element of the mastic cartridge.

12. The filling station in accordance with claim 11, further comprising counter alignment members that are formed complementary to alignment members present at the mastic cartridge, with the counter alignment members being configured to ensure a correct mechanical alignment of rigid head part at the filling station.

13. A system comprising:
a mastic cartridge for a medium to be dispensed;
a dispenser configured to dispense the medium from the mastic cartridge; and
a filling station configured to fill the mastic cartridge with the medium, the mastic cartridge comprising an Automatic Identification and Data Capture (AIDC) element configured to communicate with a corresponding element arranged at the dispenser and at the filling station.

14. The mastic cartridge in accordance with claim 1, wherein the head part includes an aperture leading from an outer side of the head part to the cartridge chamber, the cartridge further comprising a connector sealingly insertable into and removable from the aperture, the connector further having a film extending over a surface of the connector with the surface facing the cartridge chamber.

15. A connector for the mastic cartridge according to claim 1, the connector being sealingly insertable into and removable from an aperture of the rigid head part.

16. The mastic cartridge in accordance with claim 6, wherein the dispensing behavior of the mastic cartridge comprises information relating to a dispensing pressure or a clamping of the film.

17. The mastic cartridge in accordance with claim 6, wherein accepted values relating to the dispensing behavior of the mastic cartridge are stored in the AIDC element and when a determination is made that the dispensing behavior deviates from the accepted values then a decision is taken to not permit a refilling of the mastic cartridge.

18. A connector for the mastic cartridge according to claim 15, wherein the connector has a film extending over a surface of the connector with the surface facing the cartridge chamber when connected to the cartridge.
